(19) United States
(12) Patent Application Publication
(10) Pub. No.: US 2007/0062537 A1
(43) Pub. Date: Mar. 22, 2007

(54) Forehead support for a respiratory mask

(76) Inventors: Paul Chiesa, Candia, NH (US); Doug Park, Derry, NH (US); Steven Leksutin, Hillsboro, NH (US)

Correspondence Address: DEVINE, MILLIMET & BRANCH, P.A., 111 AMHERST STREET, BOX 719, MANCHESTER, NH, 03105, US

(21) Appl. No.: 11/520,140

(22) Filed: Sep. 13, 2006

Related U.S. Application Data
(60) Provisional application No. 60/717,126, filed on Sep. 14, 2005.

(51) Int. Cl. A62B 18/08

(52) U.S. Cl. 128/207.11

(57) ABSTRACT

A forehead support for a respiratory mask is disclosed. A forehead pad is connected to the shell of a respiratory mask by two support legs providing increased stability over forehead supports of the prior art. A threaded piece connects one support leg to the shell of the respiratory mask such that turning the threaded piece causes the support leg continuously to move toward or away from the respiratory mask.

### CROSS-REFERENCE TO RELATED APPLICATIONS

The present application claims the benefit of provisional application Ser. No. 60/717,126 filed Sep. 14, 2005, which is incorporated herein by reference.

### TECHNICAL FIELD

The present invention relates to a system for supporting a respiratory mask used to supply a breathable gas to a wearer. More specifically, it relates to a forehead support for both nasal and full-face respiratory masks (hereinafter, collectively, “masks”or, separately, a “mask”).

### BACKGROUND INFORMATION

A number of relatively common breathing disorders are treated by delivering pressurized, breathable gas to a patient's airways. This is customarily done through the use of a mask.

A mask is normally held in place over a patient's nose or face by one or more straps. The straps encircle the patient's head and are adjusted to create a gas tight seal between the mask and the patient's face.

In use, the mask may push too strongly on the soft tissue surrounding the patient's nose or face. Also, the mask may, during extended use, move relative to the patient's nose or face breaking the gas tight seal or becoming uncomfortable.

The prior art includes examples of a forehead support for a mask to prevent the mask from pushing too strongly on a patient's nose or face and to provide a point of contact between the mask and the patient's head, thereby reducing unwanted movement of the mask.

For example, U.S. Pat. No. 6,679,261 discloses an adjustable forehead support for a facial mask that utilizes a dual-arm system wherein the angle between the arms can be altered between predetermined positions to alter the angle of the mask relative to the patient's head.

Another example is disclosed in U.S. Pat. No. 6,532,961, in which a T-shaped forehead support is pivotally mounted to a facial mask so that it moves about an axis substantially parallel to the upper cross portion of the T-shaped support. The forehead support is selectively lockable at one of a number of predetermined angular positions.

It is an object of the present invention to provide an alternative form of forehead support for a mask that provides increased stability for the mask relative to a patient's face.

It is a further object of the present invention to provide a form of forehead support wherein the position of the forehead support is continuously adjustable.

It is yet a further object of the present invention to provide a form of forehead support wherein the piece of the forehead support that contacts a patient's head more readily adjusts to the relative location of the patient's forehead.

### SUMMARY OF THE INVENTION

The present invention is a forehead support for a respiratory mask. In a preferred embodiment, a forehead pad is pivotally connected to one end of a cross-piece, providing a more readily adjustable contact with a patient's forehead than forehead supports of the prior art. The cross piece is, in tern, pivotally connected to the ends of two support legs of uneven length. The other ends of the support legs are pivotally connected to the shell of the respiratory mask. The two support legs provide increased stability for the forehead support compared to forehead supports of the prior art.

The preferred embodiment also includes a means for adjusting the position of the forehead support relative to the respiratory mask. These means take the form of a threaded piece, one end of which is inserted in a thread hole in one of the support legs such that turning the threaded piece causes the support leg to move toward or away from the respiratory mask.

### BRIEF DESCRIPTION OF THE DRAWINGS

These and other features and advantages of the present invention will be better understood by reading the following detailed description, taken together with the drawings wherein:

FIG. 1 is a front view (side away from a patient's face) of a preferred embodiment of the present invention;

FIG. 2 is a rear view (side toward a patient's face) of the preferred embodiment of the present invention shown in FIG. 1;

FIG. 3 is a side view of the preferred embodiment of the present invention shown in FIG. 1;

FIG. 4 is a more detailed side view of the preferred embodiment of the present invention shown in FIG. 3; and

FIG. 5 is a side view of an alternative preferred embodiment of the present invention.

### DETAILED DESCRIPTION OF THE PREFERRED EMBODIMENTS

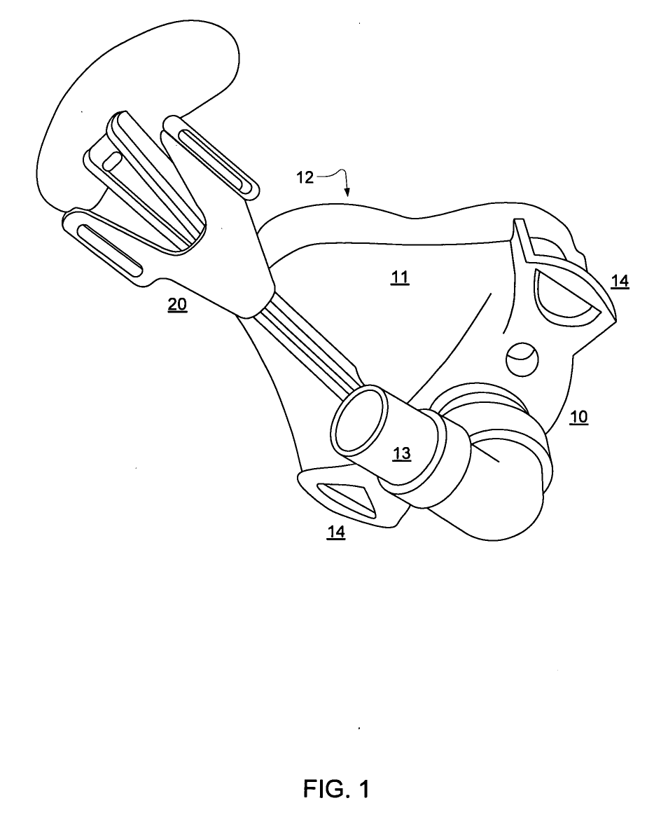

FIG. 1 shows a preferred embodiment of a forehead support for a respiratory mask according to the present invention. A respiratory mask 10 is connected to a forehead support 20. The mask 10 includes a mask shell 11 and a mask cushion 12 for contacting a patient's face. The mask shell 11 includes a connector 13 for connecting to a supply of breathable gas. The mask 10 also includes slotted connectors 14 that can be used to connect ends of a lower head strap (not shown) to the mask 10. The connectors 14 are shown here as slotted to accept the ends of the strap. The connectors 14 may employ other means of connection, including Velcro and magnets, known to those skilled in the art.

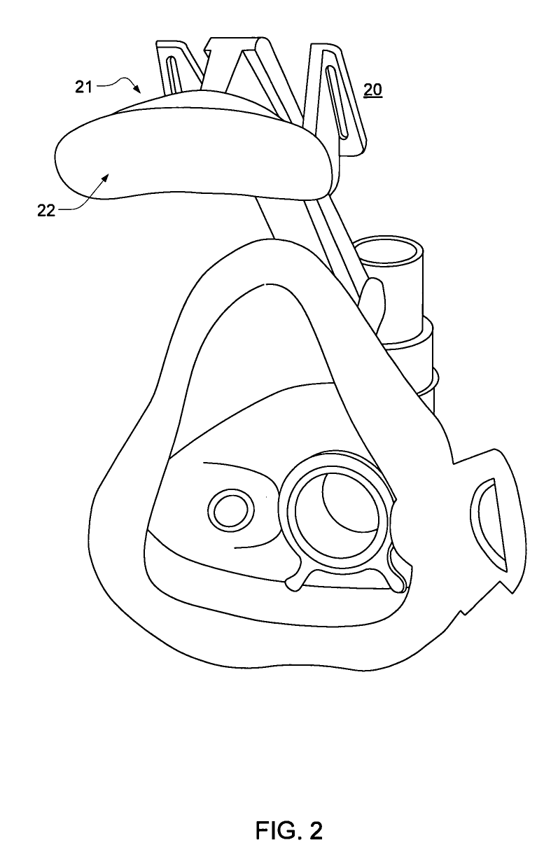

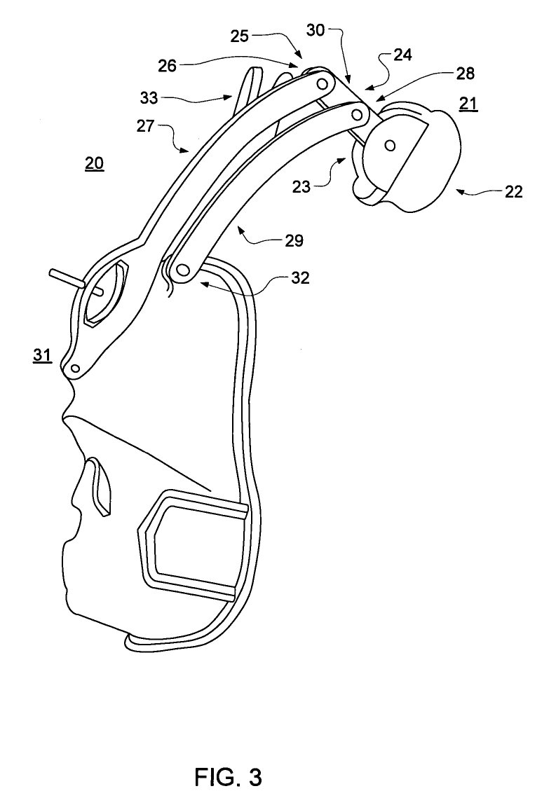

FIGS. 2 and 3 show the forehead support 20 of the present invention in more detail. It comprises a forehead pad 21 with a substantially flat face 22 that contacts a wearer's forehead. The shape of the face 22 is a “lima bean” shape in this embodiment. The forehead pad 21 is pivotally connected to the first end 23 of a cross piece 24. The second end 25 of the cross piece 24 is pivotally connected to the first end 26 of a first support leg 27. The first end 28 of a second support leg 29, which is shorter than the first support leg 27, is connected to a mid-point 30 of the cross-piece 24, which mid-point 30 is between the first end 23 and the second end 25, but need not be midway between them. The second end 31 of the first support leg 27 is pivotally connected to the mask shell 11, and the second end 32 of the second support leg 29 is pivotally connected to the mask shell 11. The cross piece 24 and the support legs 27, 29 in this embodiment are all substantially in one plane. The axes of the pivotal connections described above are all substantially orthogonal to this plane. The two support legs 27, 29 are employed to increase the stability of the forehead pad 21 relative to the mask 11.

The first support leg 27 includes connectors 33 that can be used to connect ends of an upper head strap (not shown) to the first support leg 27. The connectors 33 are shown here as slotted to accept the ends of the strap. The connectors 33 may employ other means of connection, including Velcro and magnets, known to those skilled in the art. Alternatively, in another embodiment, the second support leg 29 may include the connectors.

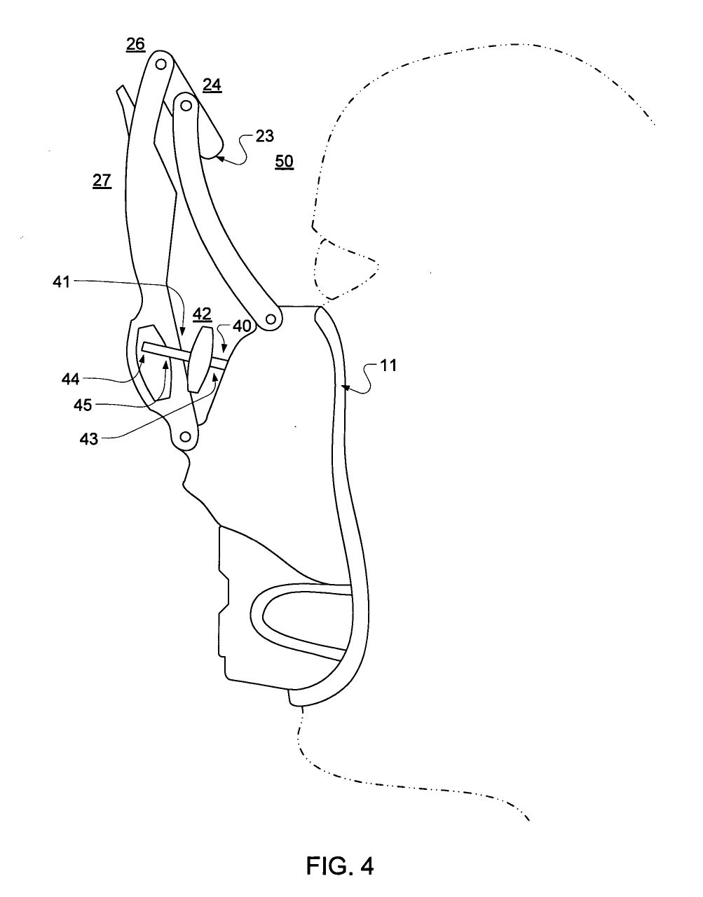

The system for supporting a mask of the present invention also includes a means for continuously adjusting the position of the forehead support 20. As shown in FIG. 4 for the first embodiment, the first end 40 of a threaded piece 41 is attached to the mask shell 11 so that the threaded piece 41 can be turned freely by the knob 42, or other means to turn the threaded piece 41, attached to a mid point 44 of the threaded piece 41, which mid-point 44 is between the first end 40 and the second end 44, but need not be midway between them. The second end 44 of threaded piece 41 is inserted into a threaded hole 45 in the first support leg 27 so that turning the threaded piece 41 causes it continuously to move the first support leg 27 toward or away from the mask 10, thereby moving the first end 23 of the cross piece 24 toward or away from the mask shell 11 and the forehead 50 of a wearer. Alternatively, in another embodiment, (not shown), the second end of the threshold piece is inserted into a threaded hole in the second support leg.

The movement of the first end 26 of the first support leg 27 causes the cross piece 24 to rotate around both the point at which first support leg 26 is pivotally attached to it and the point at which the second support leg 29 is pivotally attached to it. This in turn causes the first end 23 of the cross piece 24 to trace an elliptical path. In another embodiment (not shown), if the forehead pad is connected to the first end of the cross-piece so that the forehead pad does not pivot, it will “roll” over the patient's forehead as it travels the elliptical path. In the preferred embodiment of FIG. 4, because the forehead pad 21 is pivotally connected to the first end 23 of the cross-piece 24, the face 22 of the forehead pad always maintains the same flat contact with the wearer's forehead 50 increasing the stability of the mask 10 relative to the wearer's face.

Referring again to FIGS. 3 and 4, the forehead pad 21 may be formed from a number of materials including foam or silicone and may be one pad or multiple pads joined together. The forehead pad 21 may also include a frame to hold said pad or pads. The cross piece 24, first support leg 27, and second support leg 29 are preferably made of plastics, but other similar materials known to those skilled in the art may be used. The threshold piece 41 and knob 42 it are preferably made of brass or stainless steel, but other similar materials known to those skilled in the art may be used.

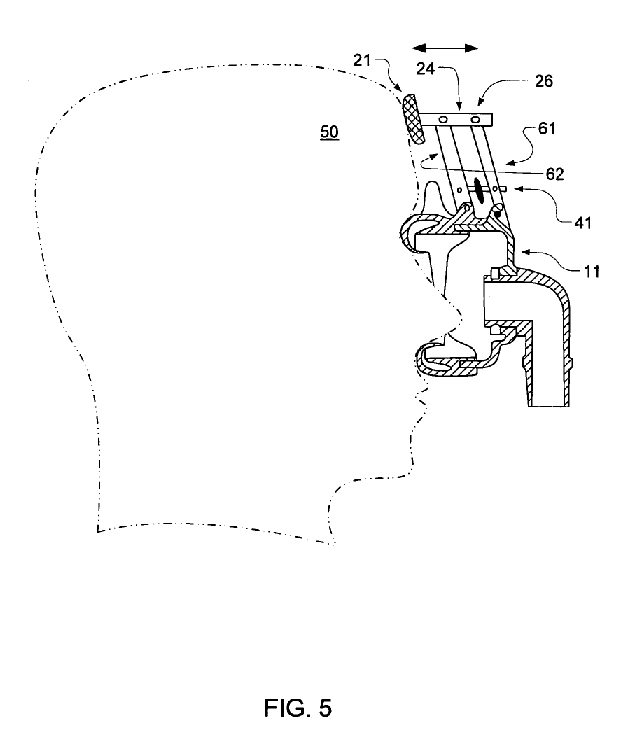

FIG. 5 shows a second embodiment of the forehead support of the present invention that is substantially similar to the first embodiment described above except that in this embodiment, the first support leg 61 and the second support leg 62 are equal length. Turning the threaded piece 41 again causes first end 63 of the first support leg 61 to move toward or away from the mask shell 11, thereby moving the forehead pad 21 toward or away from the wearer's forehead 50. However, when the support legs 61 and 62 are equal length, the cross piece 24 does not rotate. It moves both horizontally and vertically without rotation. This motion may further increase the stability of the mask 10 relative to the wearer's face.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A forehead support for a respiratory mask, having a mask shell, comprising
a forehead pad;
a cross piece having a first end, a mid-point and a second end, the first end being pivotally connected to the forehead pad;
a first support leg having a first end and a second end, the first end being pivotally connected to the second end of the cross-piece and the second end being pivotally connected to the mask shell;
a second support leg that is shorter than the first support leg, the second support leg having a first end and a second end, the first end being pivotally connected to the mid-point of the cross-piece and the second end being pivotally connected to the mask shell.

2. The forehead support of claim 1 wherein the cross-piece, the first support leg, and the second support leg are all in substantially the same plane.

3. The forehead support of claim 2 wherein the axes of the pivotal connections of the first end of the cross-piece to the forehead pad, the first end of the first support leg to the second end of the cross-piece, the second end of the first support leg to the mask shell, the first end of the second support leg to the mid-point of the cross-piece, and the second end of the second support leg to the mask shell are all orthogonal to said plane.

4. The forehead support of claim 1 further comprising means to attach the ends of a head strap to the first support leg.

5. The forehead support of claim 1 further comprising means to attach the ends of a head strap to the second support leg.

6. The forehead support of claim 1 further comprising a threaded piece having a first end, a mid-point, and a second end, the first end being connected to the mask shell so that the threaded piece turns freely, the second end being inserted into a threaded hole in the first support leg, and the mid-point having a means to turn the threaded piece causing the first support leg continuously to move toward or away from the mask shell.

7. The forehead support of claim 1 further comprising a threaded piece having a first end, a mid-point, and a second end, the first end being connected to the mask shell so that the threaded piece turns freely, the second end being inserted into a threaded hole in the second support leg, and the mid-point having a means to turn the threaded piece causing the second support leg continuously to move toward or away from the mask shell.

8. A forehead support for a respiratory mask, having a mask shell, comprising
a forehead pad;
a cross piece having a first end, a mid-point and a second end, the first end being connected to the forehead pad;
a first support leg having a first end and a second end, the first end being pivotally connected to the second end of the cross-piece and the second end being pivotally connected to the mask shell;
a second support leg that is shorter than the first support leg, the second support leg having a first end and a second end, the first end being pivotally connected to the mid-point of the cross-piece and the second end being pivotally connected to the mask shell.

9. A forehead support for a respiratory mask, having a mask shell, comprising
a forehead pad;
a cross piece having a first end, a mid-point and a second end, the first end being pivotally connected to the forehead pad;
a first support leg having a first end and a second end, the first end being pivotally connected to the second end of the cross-piece and the second end being pivotally connected to the mask shell;
a second support leg that is substantially the same length as the first support leg, the second support leg having a first end and a second end, the first end being pivotally connected to the mid-point of the cross-piece and the second end being pivotally connected to the mask shell.
